(19) United States
(12) Patent Application Publication
(10) Pub. No.: US 2020/0149346 A1
(43) Pub. Date: May 14, 2020

(54) SCREEN DEVICE

(71) Applicant: RENSON SUNPROTECTION-SCREENS NV, Waregem (DE)

(72) Inventors: Maxim Gustave SOLOMANIUCK, Gent (BE); Louis Jonas CORTVRIENDT, Oostende (BE); Steven Rita André VANHOUTTE, Deerlijk (BE); Sofie RUMBAUT, Gent (BE); John Peter MEINSTER, Gentbrugge (BE); Jonas Willem MAERTENS, Gent (BE); Patrick Marc PERQUY, Drongen (BE); Koen VERFAILLIE, Rumbeke (BE)

(21) Appl. No.: 16/632,398

(22) PCT Filed: Jul. 17, 2018
(86) PCT No.: PCT/IB2018/055272

§ 371 Date: Jan. 20, 2020

(30) Foreign Application Priority Data
Jul. 18, 2017 (BE) BE-2017/5507

(51) Int. Cl. E06B 9/52; E06B 9/58; A47H 23/01

(52) U.S. Cl. CPC E06B 9/52; E06B 2009/587; A47H 23/01; E06B 9/58

(57) ABSTRACT

Screen device (1) comprising a screen (2) which, on a screen edge (4), is provided with a fitting element (5), a screen slat (3) which comprises a fitting slot (6), in which this fitting element (5) is at least partly accommodable and one or several click-action means (9, 10) which are at least partly elastic in order to secure the fitting element (5) in the fitting slot (6) by means of a click-fit connection.

This application is a National Phase entry of International Application No. PCT/IB2018/055272 under § 371 and claims the benefit of Belgian patent application No. BE-2017/5507, filed Jul. 17, 2018, which is hereby incorporated by reference in its entirety.

### FIELD OF THE INVENTION

The present invention relates to a screen device, comprising a screen and a screen slat, which is fittable to a screen edge of the screen, wherein the screen, on this screen edge, is provided with a fitting element which is attached to or forms part of the screen, wherein the screen slat comprises a fitting slot, in which this fitting element is at least partly accommodable for fitting the screen slat to the said screen edge of the screen and wherein the screen slat comprises an access opening to this fitting slot, through which the screen and/or the fitting element extends in the installed position.

### BACKGROUND

With hanging screens, such screen slats are conventionally provided at the bottom of the screen in order to ensure that the screen sags satisfactorily under the weight of this screen slat. With screens which are mounted differently and/or screens which can be rolled up and unrolled, this screen slat often forms a reinforcement of the respective screen edge of the screen, in which it is possible to reliably tension the screen in the rolling and unrolling direction using tensioning systems which engage on this screen slat. In this case, the screens can be, for example, vertically rolled up and unrolled, both from a screen roller which is positioned at the top of the unrolled screen and from a screen roller which is positioned at the bottom of the unrolled screen. However, the screens can also be rolled up and unrolled in a different direction, with the screen itself being positioned horizontally, vertically, curved or at an incline.

Such screen slats may assume all kinds of forms, in which case these may, for example, have a substantially rectangular cross section, or a substantially triangular or a substantially elliptic or round cross section.

Conventionally, screen slats are usually made from two plate parts which are positioned on both sides of the screen and are bolted to each other, such as for example described in U.S. Pat. No. 1,672,647.

In U.S. Pat. No. 5,671,795, a screen slat according to this same principle is composed of two profile parts which are screwed to each other with the screen in between them.

However, it is fairly laborious to attach such a screen slat to a screen, since both slat parts on either side of the screen have to be accurately positioned with respect to each other, following which the screws or bolts have to be inserted therein.

Such screen slats are often also undesirable from an aesthetic point of view, because it is not easy to fit such a screen between the slat parts so that it is flat and does not crease, and because visible screws or bolts are undesirable.

With screen slats comprising several slat parts, the screws or bolts are therefore often replaced with alternative securing means for aesthetic reasons.

Thus, for example, NL 2 011 050, U.S. Pat. No. 1,909,109 and DE 20 2009 010 313 disclose screen slats in which the screen is clamped between both slat parts. As regards installation, these screen slats are also much simpler to fit to the screen. However, such screen slats may unintentionally come away, if forces act on the screen or the screen slat counter the clamping force.

Furthermore, it is known, for example from EP 2 730 737 A1, to clamp the screen in a groove by means of an elastic tensioning element. However, with such systems, it is difficult to securely clamp the screen in such a way that it can be kept sufficiently tensioned and free from creases.

FR 2 691 893 and JP 63-184991 describe multipart screen slats which may be attached to the screen without visible bolts or screws. In this case, the screen is provided with a thickened edge on a screen edge which is arranged between the slat parts. Using such a thickening as fastening element, it is simpler to fit the screen between the slat parts so as to be flat. In this way, it is also less easy for the screen to unintentionally come away from the screen slat.

Increasingly often, preference is given to single-part screen slats, in which a screen edge of the screen is held by providing this screen edge with a thickening as fastening element and arranging this thickening in a fitting slot of the screen slat. Such screen slats are known, for example, from EP 2 366 864, U.S. Pat. Nos. 4,393,915, 5,647,421, US 2008/0035281, JP 63-184991, EP 2 085 560 and EP 2 602 401.

However, it is relatively laborious to fit such a thickened screen edge in such a fitting slot in the screen slat, since, to this end, this thickened screen edge has to be fitted in the screen slat via one end and sufficient space has to be available next to the screen slat in order to be able to do this. In addition, in EP 2 602 401, a clamping strip is first arranged over the thickening to this end, after which these are laterally arranged in the fitting slot together.

### SUMMARY

It is an object of the present invention to provide a screen slat which is simple to mount on a screen edge of a screen, without causing creasing of the screen.

This object of the invention is achieved by providing a screen device, comprising a screen and a screen slat, which is fittable to a screen edge of the screen, wherein the screen, on this screen edge, is provided with a fitting element which is attached to or forms part of the screen, wherein the screen slat comprises a fitting slot, in which this fitting element is at least partly accommodable for fitting the screen slat to the said screen edge of the screen, wherein the screen slat comprises an access opening to this fitting slot, through which the screen and/or the fitting element extends in the installed position, and wherein the screen device comprises one or several click-action means which are at least partly elastic in order to secure the fitting element in the fitting slot by means of a click-fit connection via the access opening.

By means of such a fitting element, the screen can be kept flat when attaching it to the screen slat.

By fastening the fitting element in the fitting slot via the access opening, it no longer has to be fitted laterally in this fitting slot, so that the necessary space next to the screen slat is no longer required.

By means of such a click-fit connection, a connection between both can readily be achieved. The click-action means may in this case form part of the screen slat and/or of the fitting element and/or of one or several separate click-fit elements. Preferably, these click-action means form part of the fitting element or are attachable thereto.

In a preferable embodiment, the screen device comprises at least one detaining element which, in the mounted position, prevents the click-action means from breaking loose from the fitting slot. Such a detaining element prevents the screen slat from unintentionally breaking loose. If desired, it is also possible in this case to provide means in order to intentionally cancel the function of this detaining element again if it is desired to remove the screen slat.

More specifically, such a click-fit connection may be achieved by providing the screen slat with a flange which at least partly delimits the access opening to the fitting slot and by providing at least one click-fit leg as said click-fit means, which is elastically displaceable and, in the mounted position, engages behind the flange in order to achieve the click-fit connection. In this case, this click-fit leg preferably forms part of the fitting element or is provided so as to be attachable thereto.

Preferably, such a click-fit leg also serves as a detaining element. This click-fit leg then forms a barb which prevents the unintended release of the click-fit connection. Such a barb is a simple embodiment of such a detaining element.

Alternatively, a screen slat may, for example, also be of a multipart design, in which case a first screen part is provided with the said fitting slot and a second screen part is attached to the first screen part, after the fitting element has been click-fitted into this fitting slot and, as a detaining element, at least partly covers the access opening to this fitting slot.

Quite a number of alternative embodiments of such a detaining element are conceivable.

In a preferable embodiment, the click-fit leg extends, viewed in the mounted position, up to a certain distance from the said screen edge next to the screen and this click-fit leg is elastically displaceable in a direction from and towards the screen. In this way, the screen can be click-fitted by means of this click-fit leg in a direction as a continuation of the screen next to which this click-fit leg extends, this towards the screen slat. In the case of a hanging screen, with the screen slat hanging on the underside of the screen, the fitting slot is provided on the upper side of the screen slat. When click-fitting the screen in this way, creasing of the screen next to the click-action means can be limited.

In this case, the said distance is preferably greater than the width of the access opening. In this way, a secure and strong click-fit connection can be achieved with a relatively narrow access opening to the fitting slot in the screen slat. The narrower the access opening, the more aesthetic such a connection between the screen and the screen slat is usually deemed to be.

Viewed in the mounted position, one said click-fit leg is preferably provided, at a certain distance from the said screen edge, with a supporting rib which is upright with respect to the rest of the click-fit leg and is arranged adjacent to the screen. By means of such a supporting rib, the free opening next to the screen, at the location of this supporting rib, is minimized, as a result of which the screen slat is attached to the screen in a more stable manner.

Preferably, such a supporting rib touches the screen in the mounted position in order thus to ensure the stability of the screen slat. The screen is then preferably flexible, for example made of screen cloth, so that the screen can deflect at the location of this supporting rib during fitting of the fitting element by means of the click-action means in the fitting slot.

The click-action means of a screen device according to the present invention preferably comprise two said click-fit legs which, in the mounted position, extend on either side of the screen.

If these both click-fit legs then each comprise a supporting rib, the supporting rib of the one click-fit leg is preferably provided at a different distance from the screen edge than the distance at which the supporting rib of the other click-fit leg is provided. In this way, these supporting ribs only form a very slight obstruction to the elastic displacement of the click-fit legs, in particular with a flexible screen.

In an embodiment of a screen device according to the present invention which is deemed to be particularly aesthetic, the fitting element is welded to the screen by means of a weld seam and this weld seam is accommodated in the screen slat when the fitting element is accommodated in the fitting slot.

In a specific embodiment of a screen device according to the present invention, the click-action means comprise a fitting slot for at least partly holding the fitting element herein. By fitting the fitting element in a fitting slot of the click-action means, existing screens which have already been provided with a fitting element on a screen edge, such as for example half a zip, can easily be provided with such click-action means.

The fitting element may for example be partly held herein via a positive lock. A part of the fitting element is then held in this fitting slot, in which case the shape of this part is such that this part is enclosed in the fitting slot, in directions which are desirable for fastening. These latter directions are directions in which the fitting element is typically subjected to loads in use at the location of this connection.

In an alternative embodiment, the click-action means may form part of the fitting element.

Preferably, the click-action means form part of one and the same click-fit element.

Still more preferably, this click-fit element is configured as a click-fit profile which, in the mounted position, extends along virtually the entire length of the said screen edge in order to ensure that the screen is fastened to the screen slat as uniformly as possible, without creasing of the screen. In terms of production engineering, such click-action means may be provided in such a profile in a relatively simple manner. Alternatively, it would, for example, also be possible to provide several click-fit elements distributed over the screen edge.

The fitting element may take many shapes, including, for example, a widening of the said screen edge, such as for example a slat or a cord which is attached to the screen or is arranged in a hollow edge of the screen. More specifically, such a fitting element may for example be provided in the form of a half zip which can be welded to the screen in a known manner. In this case, the fitting element preferably extends along the entire length of the screen edge of the screen, but may also be distributed along the screen edge in several parts. It is also possible for several such fitting elements to be provided.

### BRIEF DESCRIPTION OF THE DRAWINGS

The present invention will now be explained in more detail by means of the following detailed description of some preferred screen devices according to the present invention. The sole aim of this description is to provide illustrative examples and to indicate further advantages and particulars of the present invention, and may thus by no means be interpreted as a limitation of the area of application of the invention or of patent rights defined in the claims.

In this detailed description, reference numerals are used to refer to the attached drawings, in which:

FIG. 1 shows a part of a first embodiment of a screen device according to the present invention at the location of the screen slat in cross section, cut through the screen slat;

FIG. 2 shows the part of the screen with the fitting element of the screen device from FIG. 1 separately, in cross section;

FIG. 3 shows the click-fit element of the screen device from FIG. 1 separately, in cross section;

FIG. 4 shows the part of the screen with the fitting element and the click-fit element of the screen device from FIG. 1 together, in cross section;

FIG. 5 shows the screen slat of the screen device from FIG. 1 separately, in cross section;

FIG. 6 shows a first slat part and a part of the screen with the fitting element and the click-fit element of a second embodiment of a screen device according to the present invention in cross section, in a dismantled position;

FIG. 7 shows a cross section of the first slat part and a part of the screen with the fitting element and the click-fit element from FIG. 6, in a partly mounted position;

FIG. 8 shows the first slat part and a part of the screen with the fitting element and the click-fit element from FIG. 6 in cross section, in a mounted position;

FIG. 9 shows the screen slat and a part of the screen with the fitting element and the click-fit element of the second embodiment of a screen device according to the present invention in cross section, in a mounted position, without a fixing element;

FIG. 10 shows the screen slat and a part of the screen with the fitting element and the click-fit element of the second embodiment of a screen device according to the present invention in cross section, in a mounted position, fixed with the fixing element.

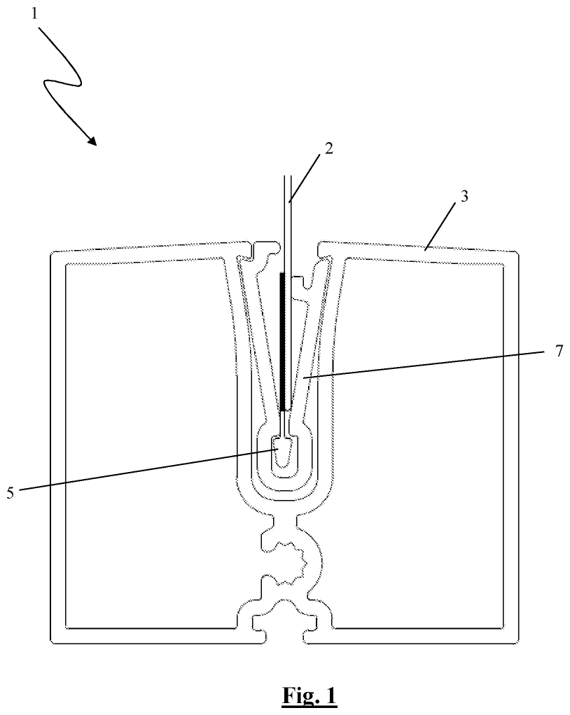

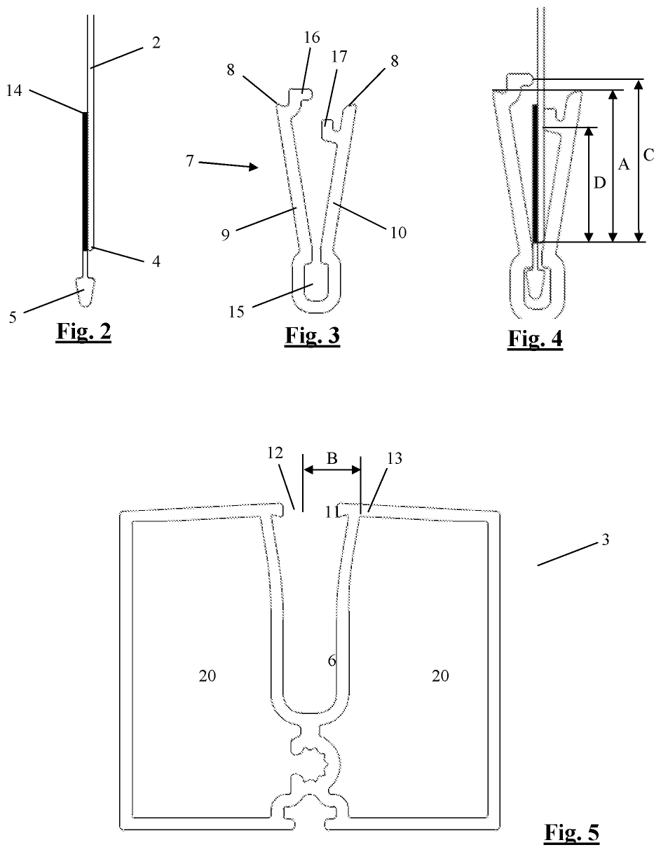

### DETAILED DESCRIPTION

The illustrated screen devices (1) comprise a screen (2) which can be rolled up on and unrolled from a screen roller (not shown). On the other side of the screen (2) from the side where this screen (2) can be rolled up on and unrolled from the screen roller, a screen slat (3) is attached.

The screen devices (1) may furthermore comprise a slat guide on both lateral sides for guiding the lateral sides of the screen (2) and/or the screen slat (3) during the rolling and unrolling movement of the screen (2).

On the side where the screen (2) is attached to the screen slat (3), the screen edge (4) is in each case provided with a thickening (5) as fitting element (5), which is configured, for example, as a half zip. In the illustrated embodiments, this thickening (5) is welded to the screen (2) in a known manner by means of a weld seam (14).

The thickening (5) is in each case held in a fitting slot (15) of a click-fit element (7) by sliding the click-fit element (7), for example beforehand, over this thickening (5) during production of the screen (2). In the first illustrated embodiment, this thickening (5) may also be click-fitted in this fitting slot (15). The further fastening of this click-fit element (7) in the screen device (1) then prevents the thickening (5) from breaking free from the click-fit element (7).

The screen slat (3) is in each case provided with a fitting slot (6), having an access opening (11) which is delimited on either side by a flange (12, 13) of the screen slat (3). The click-fit element (7) may in each case be click-fitted into this fitting slot (6), in which case click-fit legs (9, 10, 30) thereof engage being the flanges (12, 13). In the first embodiment, the click-fit element (7) comprises two flexible click-fit legs (9, 10) to this end. In the second embodiment, one click-fit leg (30) is of a rigid design and a second click-fit leg (10) is of a flexible design.

The screen slat (3) or the parts (18, 19) thereof may be made of plastic or aluminium, for example by means of extrusion.

In the illustrated embodiments, the click-fit element (7) is designed as a profile which extends along virtually the entire length of the screen edge (4). Such a click-fit profile (7) may be made from plastic, for example by means of extrusion. It would also be possible to provide several relatively short click-fit elements (7) distributed over the length of the screen edge (4). Such relatively short click-fit elements (7) may be produced, for example, by means of injection-moulding.

In the first illustrated embodiment, the click-fit legs (9, 10), viewed in the mounted position, extend on either side of the screen (2) up to a certain distance (A) from the screen edge (4) next to the screen (2) and are elastically displaceable in a direction from and towards the screen (2). This distance (A) is greater than the width (B) of the access opening (11). In this way, the access opening (11) may be made relatively narrow, which is deemed to be aesthetically pleasing. In this case, the click-fit legs (9, 10) may be made sufficiently high to be able to achieve a strong click-fit connection. In the illustrated embodiment, this height (A) is such that the weld seam (14), in the mounted position, is accommodated in the screen slat (3), which is likewise deemed to be aesthetic.

When click-fitting the click-fit profile (7) into the fitting slot (6), the click-fit legs (9, 10) serve as barbs (8) which engage behind the flanges (12, 13) and prevent the click-fit profile (7) from breaking free from the fitting slot (6).

After they have been click-fitted, the click-fit legs (9, 10) are held in the fitting slot (6) of the screen slat (3), as a result of which they can no longer move apart and the thickening (5) can no longer unintentionally break free from the fitting slot (15) in the click-fit profile (7).

Viewed in the mounted position, the click-fit legs (9, 10) are provided, at a certain distance (C, D) from the screen edge (4), with a supporting rib (16, 17) which is upright with respect to the rest of the click-fit leg (9, 10) and is arranged adjacent to the screen (2), so that the screen slat (3) is attached to the screen (2) in a stable manner. These supporting ribs (16, 17) minimize the free space next to the screen (2), so that less dirt can accumulate in the screen slat (3). The supporting rib (16) on the first click-fit leg (9) is arranged at a greater distance (C) from the screen edge (4) than the distance (D) at which the supporting rib (17) is arranged from the second click-fit leg (10). In this way, these supporting ribs (16, 17) cannot prevent the click-fit legs (9, 10) from moving toward each other, so that the click-fit connection can be achieved. When the click-fit legs (9, 10) are moving towards each other, the screen (2) will temporarily fold around these supporting ribs (16, 17).

In the second illustrated embodiment, the screen slat (3) comprises a first slat part (18) and a second slat part (19), between which the click-fit element (7) is accommodated, and which are attachable to each other.

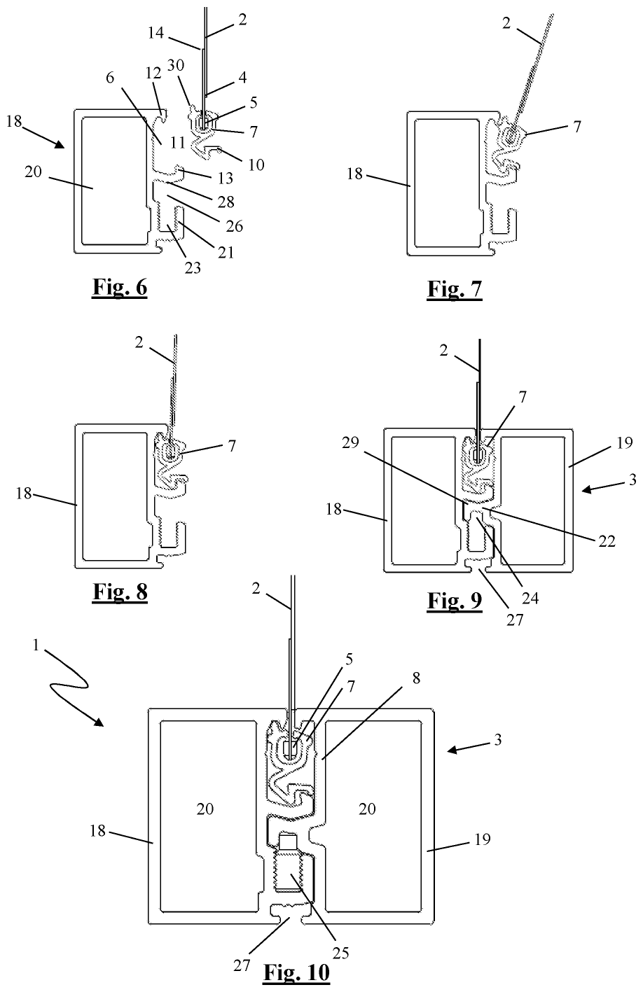

As can be seen in FIGS. 6 to 8, the click-fit element (7) may be click-fitted into the fitting slot (6) which is provided in the first slat part (18) by means of the click-fit legs (30, 10). To this end, the bottom hook-shaped click-fit leg (10) is of a flexible design. After click-fitting has taken place, the first slat part (18) is securely attached to the click-fit element (7) and the fitter has his/her hands free to take the second slat part (19) and attach it to the first slat part (18).

In order to attach the second slat part (19) to the first slat part (18), the first slat part (18) comprises an attachment recess (26) in which a fitting element (22) of the second slat part (19) is finable. The access opening for this attachment recess (26) is provided on the side, viewed in the figures. To this end, the fitting element (22) is hooked into the attachment recess (26) in such a way that it is secured against an upward or downward displacement, viewed in these figures. The fitting element (22) is furthermore provided with a securing element (29) and the attachment recess (26) is partly delimited by means of a corresponding securing element (28), so that this fitting element (22), after it has been fitted in the attachment recess (26), is also partly secured against breaking free from the attachment recess (26). In this way, the second slat part (19) may be released without it breaking free from the first slat part (18), so that the fitter has his/her hands free to secure the second slat part (19) with respect to the first slat part (18) by means of fixing elements (25) which will be described below.

In an intermediate step during the fitting of the fitting element (22) into the attachment recess (26), the second slat part (19) may first be hooked into the first slat part (18) to ensure that the fitting element (22) is secured sufficiently well in the attachment recess (26), so that the second slat part (19) can be released. The fitting of this fitting element (22) in the fitting recess (26) requires accurate positioning of the second slat part (19) with respect to the first slat part (18). The first slat part (18) comprises a first hook element (21) and the fitting element (22) of the second slat part (19) forms a second hook element (22) which can be hooked into the first hook element (21) in order to hook the second slat part (19) into the first slat part (18). For this hooking operation, the slat parts (18, 19) do not have to be so accurately positioned with respect to each other, so that these slat parts (18, 19) can be moved with respect to each other more easily when arranging the fitting element (22) in the fitting recess (26).

In order to then be able to secure the slat parts (18, 19) with respect to each other, the first slat part (18) comprises a first channel-shaped recess (23) which ends in the fitting opening (26) and the second slat part (19) comprises a second channel-shaped recess (24) which is provided in the fitting element (22). The first channel-shaped recess (24) is delimited by the first hook element (21) and the second channel-shaped recess (24) is delimited by the second hook element (22). The first channel-shaped recess (24) is configured as a screw channel. Via the underside of the screen slat (27), openings may be drilled into this screw channel (23) in order to screw fixing elements (25) therein, as can be seen in FIG. 10. These fixing elements (25) are preferably screwed into the screen slat (3) at several locations at a distance apart. These fixing elements (25) comprise a bottom part which is provided with an external screw thread which can engage in the screw channel (23). The top part of the fixing elements (25) is not threaded so that this part can easily engage into the second channel-shaped recess (24) in the second slat part (19). To this end, the fixing elements (25) are screwed sufficiently far into the screw channel (23), until the top part engages into the second channel-shaped recess (24). In this way, the slat parts (18, 19) cannot break free from each other in an undesirable manner. In this way, the second slat part (19) can serve as a detaining element (8) which prevents the click-fit profile (7) from breaking free from the fitting slot (6) in the first slat part (19).

In the channel-shaped recess (27) which is provided at the bottom of the screen slat (3), a damping profile may for example be arranged, so that when the screen slat (3) hits a surface during unrolling of the screen (2), the impact is damped. This damping profile also ensures that the fixing elements (25) are covered.

Due to the fact that the screen slat (3) comprises two slat parts (18, 19), it may adjoin the screen (2) more closely than is possible with single-part screen slats (3). This is deemed to be more aesthetic and ensures that less dirt can accumulate in the space between the screen (2) and the screen slat (3).

1. Screen device comprising a screen and a screen slat, which is fittable to a screen edge of the screen, wherein the screen, on this screen edge, is provided with a fitting element which is attached to or forms part of the screen, wherein the screen slat comprises a fitting slot, in which this fitting element is at least partly accommodable for fitting the screen slat to the said screen edge of the screen and wherein the screen slat comprises an access opening to this fitting slot, through which the screen and/or the fitting element extends in the installed position, characterized in that the screen device comprises one or several click-action means which are at least partly elastic in order to secure the fitting element in the fitting slot by means of a click-fit connection via the access opening.

2. Screen device according to claim 1, characterized in that the screen device comprises at least one detaining element which, in the mounted position, prevents the click-action means from breaking loose from the fitting slot.

3. Screen device according to claim 1, characterized in that the screen slat is provided with a flange which at least partly delimits the access opening to the fitting slot and in that the click-action means comprise at least one click-fit leg which is elastically displaceable and, in the mounted position, engages behind the flange in order to achieve the click-fit connection.

4. Screen device according to claims 2, characterized in that the click-fit leg serves as a detaining element.

5. Screen device according to claim 3, characterized in that the click-fit leg, viewed in the mounted position, extends up to a certain distance (A) from the said screen edge next to the screen and is elastically displaceable in a direction from and towards the screen.

6. Screen device according to claim 5, characterized in that the said distance (A) is greater than the width (B) of the access opening.

7. Screen device according to claim 5 or 6, characterized in that the click-fit leg, viewed in the mounted position, is provided, at a certain distance from the said screen edge, with a supporting rib which is upright with respect to the rest of the click-fit leg and is arranged adjacent to the screen.

8. Screen device according to claim 7, characterized in that, in the mounted position, the supporting rib touches the screen.

9. Screen device according to claim 1, characterized in that the click-action means comprise two said click-fit legs which, in the mounted position, extend on either side of the screen.

10. Screen device according to claim 1, characterized in that the supporting rib of the one click-fit leg is provided at a different distance from the screen edge than the distance at which the supporting rib of the other click-fit leg (10) is provided.

11. Screen device according to claim 1, characterized in that the fitting element is welded to the screen by means of a weld seam (14), and in that this weld seam is accommodated in the screen slat when the fitting element is accommodated in the fitting slot.

12. Screen device according to claim 1, characterized in that the click-action means comprise a fitting slot for at least partly holding the fitting element herein.

13. Screen device according to claim 1, characterized in that the click-action means form part of the fitting element.

14. Screen device according claim 1, characterized in that the said click-action means form part of a one and the same click-fit element.

15. Screen device according to claim 14, characterized in that the click-fit element is configured as a click-fit profile which, in the mounted position, extends over virtually the entire length of the said screen edge.

16. Screen device according to claim 1, characterized in that the fitting element is configured as a widening of the said screen edge.
